(19) United States
(12) Patent Application Publication
(10) Pub. No.: US 2008/0222707 A1
(43) Pub. Date: Sep. 11, 2008

(54) SYSTEMS AND METHODS FOR CONTROLLING SERVICE ACCESS ON A WIRELESS COMMUNICATION DEVICE

(75) Inventors: Hanumantha Rao Pathuri, San Diego, CA (US); An Mei Chen, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/683,343

(22) Filed: Mar. 7, 2007

(51) Int. Cl. H04L 9/32

(52) U.S. Cl. 726/4

(57) ABSTRACT

Methods, devices, systems and computer program products are provided for controlling access to services, content, applications and the like on a wireless communication device. In one aspect, wireless communication device-wide access control is provided such that unified access control may exist on the device; providing access control to more than one, and in some instances all, of the services and/or applications that are accessible on the device. Additionally, aspects provide for limiting or prohibiting access based on numerous access control factors, such as content type, service type, location of the device, time or any other device environmental characteristic. The methods, devices, systems and computer program products for content access control may be executed on the wireless communication device or they may be executed within the wireless network.

### BACKGROUND

1. Field

The disclosed aspects relate to wireless communication devices, and more particularly, to methods and apparatus for controlling access to services, applications and content on a wireless communication device.

2. Background

Wireless communication devices have become a prevalent means by which majorities of people worldwide have come to communicate. As the cost of such devices and the cost of the services related to such devices, such as cellular telephone services, decreases, the overall penetration of such devices among the general populous increases. No longer are wireless communication devices limited to business use and/or emergency communication, but rather they have become commonly used in all facets of life.

Whereas the conventional wireless communication device may have been limited in functionality, such as limited to cellular telephone communication, many of today's wireless communication devices are multifunctional devices capable of providing multiple functions and/or access to multiple wireless services. For example, wireless communication devices may be equipped with the ability to access the Internet and, in this regard, web based services, such as audio, video and multimedia services and the like. Additionally, wireless communication devices are currently available with access to broadcast video and/or audio services, including mobile television. Wireless communication devices may also be configured to communicate via electronic mail, Short Message Service (SMS) (e.g. text messaging), Push-to-Talk (PTT) and the like. In addition to wireless network services, wireless communication devices may include various applications, such as video gaming applications, audio and/or video player applications and the like.

With such widespread use of wireless communication devices and the ability of each device to provide numerous communication means, access multiple network services and include numerous applications, the ability to provide control over the access to such communication means, network services and applications becomes of greater concern. For example, a parent that has provided a child with a wireless communication device desires the ability to control the child's communication on the device, the content and applications accessed on the device by the child and the like. In this instance, a parent may desire to set a content rating limit on the device that limits access to content/services that meet the set acceptable limit. However, the control of service and/or content access on the wireless communication device is not limited to merely prohibiting the user from accessing a service, content and/or an application. In certain instances a parent may be willing to grant a child access to a service, content or an application, while in other instances a parent may want to control (i.e., limit or prohibit) access to a service, content or an application. For example, when the child is in school during normal school hours, the parent may desire to prohibit access to all non-school related functions/applications/services and limit access to cellular services, such that the child may only make or receive calls from the parent or another designated emergency contact. In another example, the parent may desire to control access on the wireless device when the child is at home, during those times designated by the parent as study time.

Controlling access on a wireless device is not limited to the parent/child model. In many other instances an entity may desire access control over wireless devices. For example, an employer may desire to control access to employee's wireless devices at the workplace to insure that the employee is engaged in business related matters as opposed to personal matters. Additionally, public places, such as churches, performance halls, government buildings, and the like may desire to control the access to those within their confines to insure that the service, performance or proceedings are not disrupted by an audible ring-tone or the user conversing. However, in both instances the entity desiring control over the device may desire to limit access to services/content/applications without necessarily completing prohibiting the use of the wireless communication device.

Additionally, the user of the wireless device may desire to control access, such as, limiting the amount of minutes for calls during a high rate period, such as during weekdays, while allow unlimited minutes for calls at night or during the weekend. Currently wireless communication devices may provide for tracking the amount of minutes used, but do not offer the user the ability to control the amount of minutes for calls during prescribed time periods.

Currently, access control of services or applications is limited to individual control on a service or application basis. This means that a wireless device user may configure an application or a service available on the wireless communication device to provide certain facets of content access control for that particular application or service. For example, a user may configure a web browser application to limit the type of content that is accessible or a user may configure an SMS application to limit from whom they may receive communications. However, currently no wireless communication device is available that offers device-wide access control. For example, limiting communication to certain individuals regardless of which communication service is used or limiting the content that is accessible regardless of which service is used to access the content.

Therefore, a need exists for systems and methods for controlling access to services, content and/or applications or a wireless communication device. The desired systems and methods should allow for user configuration of the access control or a device controlling entity, such as a parent, an employer or the like. In addition, The desired systems and methods should be capable of providing device-wide content access control or to preconfigured services, applications and content as a user or a controlling entity desires. The desired systems and methods should not only prohibit access to services, content and/or applications but also provide for limiting access to services based on other factors, such as device location, time of day, week or the like, communication party, type of content and the like.

### SUMMARY

Present aspects provide for methods, devices, systems and computer program products for controlling access to services, content, applications and the like on a wireless communication device. In one aspect, wireless communication device-wide access control is provided such that unified access control may exist on the device; providing access control to more than one, and in some instances all, of the services, content and/or applications that are accessible on the device. Additionally, aspects provide for limiting or prohibiting access based on numerous access control factors, such as content type, service type, location of the device, time or any other device environmental and/or state characteristic. The methods, devices, systems and computer program products for content access control may be executed on the wireless communication device or they may be executed within the wireless network.

In one aspect a method for controlling service access on a wireless communication device is defined. The method includes receiving at least one access control privilege that includes at least one access control attribute and is associated with a wireless communication device and storing the access control privileges in memory. Each access control privilege controls access to a plurality of services available on the wireless communication device. In this regard, the access control privileges may be configured to apply to any and/or all of the services available on the wireless device. In addition to network services, the method may control access to local or network content and/or local or network applications. The method additionally includes receiving a request to access one of the plurality of services available on the wireless communication device, and controlling access to the service if it is determined that the at least one stored access control privilege applies to the access request. Controlling access to the service may include prohibiting access and/or limiting access according to the control access privilege.

The access control attributes that define the access control privileges may include a predetermined geographic location of the wireless communication device or a predetermined time period. Additionally, access control attributes may include, but are not limited to, a predetermined type of service, a predetermined type of content, from whom communication may be received, from whom communication mat be transmitted, such as a predetermined URL address, a predetermined short message service address, a predetermined mobile identification number and any combination of the aforementioned attributes.

The access control privileges may be received and/or stored at the wireless communication device or at a network interface. If the access control privileges are received and/or stored at the wireless communication device, typically a user will provide input via an appropriate user interface. If the access control privileges are received at a network interface, such as a server or the like, a user and/or a third party entity, such as a parent, employer or the like, may provide input via a network connection, such as the Internet, private network or the like. In this instance, the access control privileges may be stored at the network entity or they may be communicated to the wireless communication device for local storage. Additionally, the access control privileges may be received by pre-configuration at the device manufacturer and/or a network service provider.

If the access control privileges are received and stored locally at the wireless communication device then, controlling access to the service may occur locally at the wireless communication device. However, in alternate aspects, typically in which the access control privileges are received and/or stored at a network entity, controlling access to the service may occur remotely at a network entity.

A related aspect is defined by at least one processor configured to perform the actions of receiving at least one access control privilege that includes at least one access control attribute and is associated with a wireless communication device and storing the access control privileges in memory. Each access control privilege controls access to a plurality of services available on the wireless communication device. Additionally, the at least one processor is configured to perform the actions of receiving a request to access one of the plurality of services available on the wireless communication device, and controlling access to the service if it is determined that at least one of the stored access control privileges apply to the access request.

Another related aspect is provided for by a computer program product that includes a computer-readable medium. The computer-readable medium includes a first set of codes for causing a computer to receive at least one access control privilege that includes at least one access control attribute associated with a wireless communication device. Each access control privilege controls access to a plurality of services available on the wireless communication device. The computer-readable medium also includes a second set of codes for causing a computer to store the access control privileges in memory, a third set of codes for causing a computer to receive a request to access one of the plurality of services available on the wireless communication device, and a fourth set of codes for causing a computer to control access to the service if it is determined that at least one of the stored access control privileges apply to the access request.

Yet another related aspect is defined by a device, such as a wireless communication device or a network device. The device includes means for receiving at least one access control privilege that includes at least one access control attribute and is associated with a wireless communication device, wherein each access control privilege controls access to a plurality of services available on the wireless communication device, means for storing the at least one access control attribute in memory, means for receiving a request to access one of the plurality of services available on the wireless communication device, and means for controlling access to the service if it is determined that the at least one stored access control privileges apply to the access request.

A wireless communication device defines a further aspect. The device includes a computer platform including a processor and a memory. The device also includes an access control module stored in the memory and in communication with the processor. The access control module is operable to receive at least one access control privilege that includes at least one access control attribute that controls access to a plurality of services available on the wireless communication device, store the at least one access control attribute in the memory, and control access to the service if it is determined that at least one stored access control privileges apply to the access request.

The wireless device may additionally include a location determination device, such as GPS device or the like, in communication with the processor and operable to communicate device location information to the access control module. In such aspects, the access control module may be further operable to determine access control to the one or more services based a content access privilege related to the location information. Similarly, the wireless device may additionally include a clock device in communication with the processor and operable to communicate time information to the access control module. In such aspects, the access control module may be further operable to determine access control to the one or more services based on a content access privilege related to the time information.

The wireless communication device may further include a user interface operable for receiving the at least one access control privilege from a device user or, in other aspects, the access control module is further operable to receive the access control privileges from a wireless network device, such as in the instances in which the access control privileges are provided by a third party entity, such as a parent, employer or the like, a network service provider or a device manufacturer.

A network device defines another aspect. The network device includes a computer platform including a processor and a memory and an access control privilege database stored in the memory and operable to receive one or more access control privileges associated with a predetermined wireless communication device. The network device further includes a communication module operable to communicate access control privileges to at least one of the predetermined wireless communication device or a network device. The access control privilege database may further be operable to receive one or more access control privileges from the predetermined wireless device user, a third party entity, such as a parent, employer, a network service provider or the like, in networked communication with the network device. The network device may be further operable to communicate the access control privileges to the predetermined wireless communication device or, alternatively, the network device may be further operable to communicate the access control privileges to a network access control filter device. In another aspect, the network device may include a network access filter module operable to wirelessly receive access service requests from a wireless communication device, and control access to the service if it is determined that one or more access control privileges are associated with the wireless communication device and the service request.

A network device defines a further aspect. The network device includes a computer platform including a processor and a memory. The network device additionally includes a network access filter module operable to wirelessly receive access service requests from a wireless communication device, determine if access control privileges are associated with the service and control access to the service if it is determined that one or more access control privileges are associated with the service request. In determining if the access control privileges are associated with the wireless communication device, the network access filter module may further be operable to communicate with an access control server to retrieve any associated access control privileges. Alternatively, the network device may include an access control attribute database that includes a listing of access control privileges and an associated wireless communication device and the network access filter module may further be operable to communicate with the access control attribute database to determine if access control privileges are associated with the wireless communication device.

Yet another aspect is provided for by a system for controlling access to services on a wireless communication device. The system includes an access control server including an access control database that is operable to receive access control privileges that control access to a plurality of services available on wireless communication devices. The system also includes a plurality of wireless communication devices including a computer platform including a processor and a memory. The wireless communication devices further include an access control module stored in the memory and in communication with the processor that is operable to wirelessly receive one or more access control privileges from the access control server, store the one or more access control privileges in the memory, determine if one or more of the stored access control privileges apply to an access attempt and control access to the service if it is determined that the stored access control privileges apply to the access attempt.

A further aspect is provided for by another wireless communication system for controlling access to services on a wireless communication device. The system includes a plurality of wireless communication devices and a first network device. The first network device includes computer platform including a processor and a memory and a network access filter module. The network access filter module is operable to wirelessly receive access service requests from the plurality of wireless communication device, determine if access control privileges are associated with the access-requesting, wireless communication device and control access to the service if it is determined that one or more access control privileges are associated with the wireless communication device and the service request.

The system may further include a second network device including a computer platform that includes a processor and a memory, and an access control attribute database stored in the memory and operable to receive one or more access control privileges associated with a predetermined wireless communication device. In such aspects, the first network device communicates with the second network device to determine if access control privileges are associated with the access-requesting, wireless communication device. Additionally, the system may include a third network device that includes a computer platform including a processor and a memory, and an device-location database stored in the memory and operable to receive device-location information from the plurality of wireless communication devices. In such aspects, the third network device communicates the device-location information to the first network device if one or more of the determined access control privileges related to device location.

Thus, present aspects provide for methods, devices, computer program products and systems for controlling access to services, including content and applications, on a wireless communication device. The aspects may be configured such that access control is provided through predefined access control privileges to any and/or all of the services, content and/or applications accessible on the wireless communication device. Additionally, aspects provide for limiting or prohibiting access based on numerous access control factors, such as content type, service type, location of the device, time or any other device environmental characteristic. The methods, devices, systems and computer program products for content access control may be executed on the wireless communication device or they may be executed within the wireless network.

### BRIEF DESCRIPTION OF THE DRAWINGS

The disclosed aspects will hereinafter be described in conjunction with the appended drawings, provided to illustrate and not to limit the disclosed aspects, wherein like designations denote the elements, and in which:

FIG. 1 is a block diagram of a wireless device-based system for controlling access on a wireless communication device, in accordance with an aspect;

FIG. 2 is block diagram of a network device-based system for controlling access on a wireless communication device, in accordance with an aspect;

FIG. 3 is a block diagram of a wireless device for controlling access on the wireless communication device, in accordance with another aspect;

FIG. 4 is a block diagram of a network device for controlling access to a wireless communication device, in accordance with an aspect;

FIG. 5 is a block diagram of a network device for receiving and storing access control privileges, in accordance with another aspect;

FIG. 6 is a block diagram that illustrates a method for controlling access in a wireless communication device; specifically prohibiting a communication call from being received based on a location based access control attribute, according to an aspect;

FIG. 7 is a block diagram that illustrates a method for controlling access in a wireless communication device; specifically prohibiting a web server from communicating data to a wireless communication device based on a location based access control attribute, according to an aspect;

FIG. 8 is a block diagram that illustrates a method for controlling access in a wireless communication device; specifically prohibiting a communication call from being placed based on a time based access control attribute, according to an aspect;

FIG. 9 is a block diagram that illustrates a method for controlling access in a wireless communication device; specifically prohibiting a wireless device from accessing a web server based on a location based access control attribute, according to an aspect; and

FIG. 10 is a flow diagram of a method for method for controlling access on a wireless communication device, according to another aspect.

### DETAILED DESCRIPTION

The present devices, apparatus, methods, computer program products and processors now will be described more fully hereinafter with reference to the accompanying drawings, in which aspects of the invention are shown. The devices, apparatus, methods, computer program products and processors may, however, be embodied in many different forms and should not be construed as limited to the aspects set forth herein; rather, these aspects are provided so that this disclosure will be thorough and complete, and will fully convey the scope of the invention to those skilled in the art. Like numbers refer to like elements throughout.

The various aspects are described herein are in connection with a wireless communication device. A wireless communication device can also be called a subscriber station, a subscriber unit, mobile station, mobile, remote station, access point, remote terminal, access terminal, user terminal, user agent, a user device, or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem.

Present aspects provide for systems, methods, devices and computer program products for controlling access to services, content and/or applications on a wireless communication device. The aspects may be configured such that access control is provided through predefined access control privileges that apply to any and/or all of the services, content and/or applications accessible on the wireless communication device. In this regard, the aspects may provide for access control on a device level, as opposed to a service or application level. Additionally, aspects provide for limiting or prohibiting access based on numerous access control factors, such as content type, service type, and environmental attributes, such as location of the device, time and the like. As will be discussed at length below, the methods, devices, systems and computer program products for content access control may be executed on the wireless communication device, within the wireless network or a combination of the wireless communication device and the network.

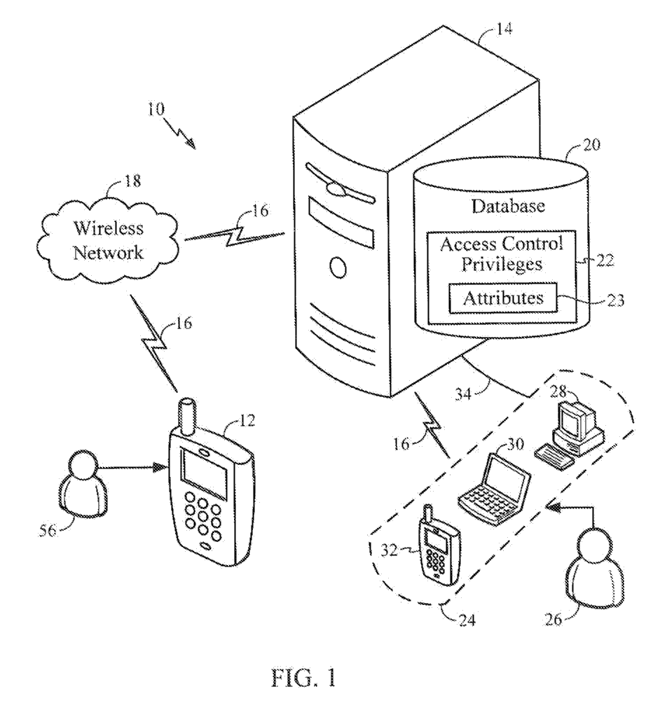

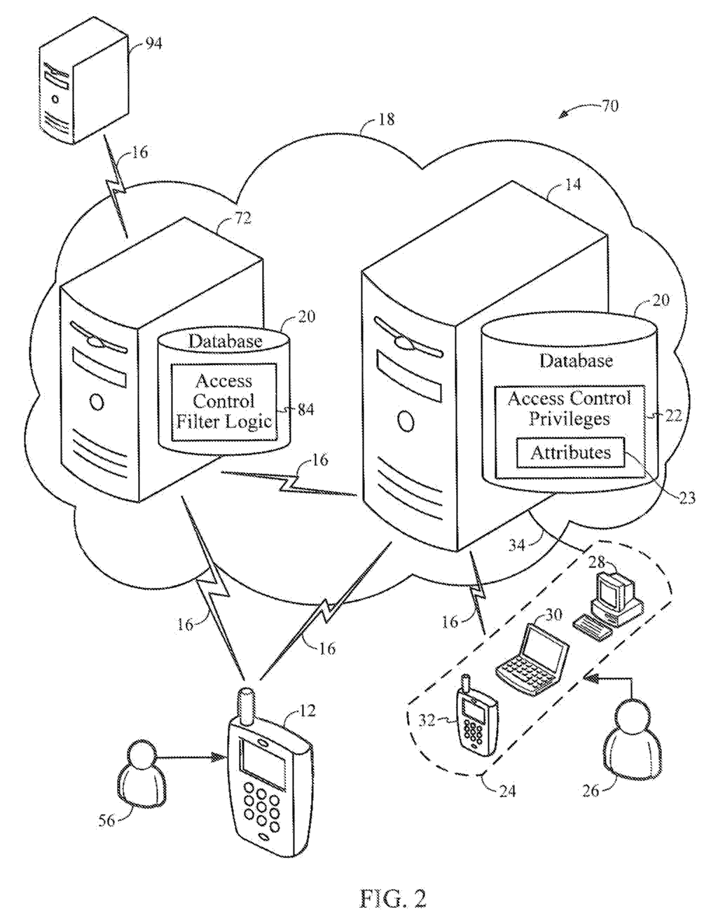

Referring to FIG. 1, a block diagram of a system 10 for providing access control in a wireless communication device is depicted. In the illustrated aspect of FIG. 1, the access control determination process is executed at the wireless communication device. As will be discussed in relation to FIG. 2, further aspects provide for the access control determination process to be executed at a network device, such as an access control filter device or the like. The system 10 described in FIG. 1 includes wireless communication device 12 and network device 14, which are in wireless communication 16 via wireless network 18.

In some aspects, the network device 14 provides for an access control database 20 that receives, access control privileges 22 communicated from a wireless communication device 12 and/or communication device 24 that is operated by a third party entity/user 26. Access control privileges 22 are rules assigned to the wireless device to control access to services, content and/or applications that are accessible to or reside within the wireless device. Access control privileges 22 include one or more access control attributes 23, which define the parameters for access control. Access control attributes 23 include, but are not limited to, from whom communication may be received, to whom communication may be placed, content type, service type, communication length (in time), environmental attributes, such as geographical location of the wireless communication device, time of day, time of week and the like.

The third party entity/user 26 may be, for example, the wireless device user, a parent having control over device access, an employer having control over device access, a network service provider, a device manufacturer or any other entity that may be authorized to control access to wireless communication device 12. The third party entity/user 26 may communicate the access control privileges 22 via any known communication device 24, such as personal computer 28, laptop 30, wireless communication device 32 or the like. As such, communication device 24 may be in wired communication 34 or wireless communication 16 with network device 14. Communication device 24 may interface with network device 14 through a conventional network interface, such as an Internet based web site, a private network portal or the like, which is implemented to receive access control privileges 22 from communication device 24, store the privileges in database 20 and communicate the access control privileges to wireless communication device 12.

The wireless communication device 12 includes a communications module 38 associated with a computer platform 36 having a memory 40 and a processor 42. In some aspects, communications module 38 is operable to receive access control privileges 22 communicated from network device 14 and to internally communicate the privileges to memory 40. In other aspects, privileges 22 are entered directly into wireless device 12, as discussed below. Memory 40 includes an access control module 44 including access control filter logic 46 that is operable to determine if one or more access control privileges 22 apply to an access attempt associated with service 48, content 50 and/or application 52. The access control privileges 22 may be configured to prohibit or otherwise limit access to a service 48, content 50 and/or any application 52 in terms of any preconfigured access control attributes 23. The access control privileges 22 may be configured such that they control access to more than one service 48 and, in some aspects, all of the services 48 available on the wireless communication device. In this regard, the access control privileges 22 may be configured such that they control access to multiple content 50 items and/or multiple applications 52 and, in some aspects, all of the content 50 and/or applications 52 residing on and/or accessible to the wireless communication device 12.

Additionally, in some aspects, access control module 44 may include an access control user interface module 54 operable for providing wireless communication device user 56 with an interface, such as a display interface or the like, that allows user 56 to view and/or configure access control privileges 22. Configuring the access control privileges 22 may include, but is not limited to, inputting, modifying, suspending and/or activating the access control privileges. It should be noted that the access control privileges 22 may be preconfigured to allow for user modification, suspension or the like or, alternatively, certain access control privileges 22 may be preconfigured such that user is not authorized to make changes to the access control privileges. For example, if the access control privileges are configured by a third party entity, such as a parent or an employer, the privileges may be configured such that user 56 is not authorized to make changes. Alternatively, if the privileges have been configured by user 56, then the privileges may be configured to allow for modification, suspension or the like. Additionally, access control interface module 54 may provide for a user interface, such as visual display, that notifies user 56 when an access control privilege 22 is being implemented to control access, such as when user 56 is attempting to access a service 48, content 50 or an application 52, e.g. a service denied message. In addition to providing notification that access is being prohibited or limited the user interface module 54 may provide for the user to modify or temporarily suspend the access control for this access attempt.

The computer platform 36 of wireless communication device 12 includes processor 42 that is operable to provide processing capability to communication module 36 and access control module 44. In this regard, processor 42 provides processing capability to allow access control filter logic 46 to determine if one or more access control privileges 22 apply to an access attempt. The processor 42 may additionally include processing subsystems 58 that are operable to enable the functionality of communication device 12 and the operability of the communication device on wireless network 18. The processing subsystems 58 may include components that provide environmental and/or state information to the access control module 44. For example, in some aspects, access control privileges 22 may include attributes 23 that provide for location-based or time-based access control. In such aspects, the processing subsystems 58 may include position determining subsystem 60, such as a Global Positioning System (GPS) subsystem or the like, operable for determining a geographic location of the device and/or a clock subsystem 62 operable for determining a time at which an access attempt occurs. Additional subsystems (not shown) may also be included as needed depending on the environmental and/or state conditions required to determine a predefined access control attribute 22.

FIG. 2 provides a block diagram illustration of a system 70 for providing access control in a wireless communication device is depicted. In the illustrated aspect of FIG. 2, the access control determination process for network service access is executed at a network communication device such as access filter network device 72. Additionally, the system may provide for wireless communication-based access control of content and/or applications that reside on wireless communication 12. The system 70 includes wireless communication device 12, network device 14 and network device 72 which are in wireless communication 16 via wireless network 18. In operation, a service access attempt may be initiated by wireless communication device 12 or another communication device, either a wired or wireless device, may attempt to initiate communication with wireless communication device 12. The access attempt is intercepted by network device 72, which acts as an access control filter to verify that access control is enabled at wireless device 12 and checks with network device 14 to determine if any access control privileges 22 apply to the access attempt. If it is determined that access control privileges 22 apply, then network device 72 prohibits or limits the access according to the preconfigured access control attributes 23.

The network device 14 provides for an access control database 20 that receives, access control privileges 22, as defined by access control attributes 23, which are communicated from a wireless communication device 12 and/or communication device 24 that is operated by a third party entity/user 26. The third party entity/user 26 may be, for example, the wireless device user, a parent having control over device access, an employer having control over device access, a network service provider, a device manufacturer or any other entity that may be authorized to control access to wireless communication device 12. The third party entity/user 26 may communicate the access control privileges 22 via any known communication device 24, such as personal computer 28, laptop 30, wireless communication device 32 or the like. As such, communication device 24 may be in wired communication 34 or wireless communication 16 with network device 14. Communication device 24 may interface with network device 14 through a conventional network interface, such as an Internet based web site, a private network portal or the like, which is implemented to receive access control privileges 22 from communication device 24, store the privileges in database 20 and communicate the access control privileges to wireless communication device 12.

Network device 72 is operable for determining if access control privileges 22 apply to access attempts made by wireless communication devices, such as wireless communication device 12. As such, network device 12 includes a communications module 76 and a computing platform 74 having a memory 78 and a processor 80. Communication module 76 is operable to request and receive access control privileges 22 communicated from network device 14, to receive access requests from wireless communication devices, such as wireless communication device 12, and to notify the wireless communication devices if access has been denied or limited based on access control privileges. Memory 78 includes an access control module 82 including access control filter logic 84. The access control filter logic 84 is operable to intercept access attempts and determine if one or more access control privileges 22 apply to an access attempt. The access control privileges 22 may be configured to prohibit or otherwise limit access to a networked service in terms of any preconfigured access control attribute. Control attributes 23 may include, but are not limited to, from whom communication is received, to whom communication is placed, content type, service type, communication length (in time), environmental attributes, such as geographical location of the wireless communication device, time of day, time of week and the like. The access control privileges 22 may be configured such that they control access to more than one service 24 and, in some aspects, all of the services 48 available on the wireless communication device.

Additionally, the computing platform 74 of network device 72 includes processor 80 that is operable to provide processing capability to communication module 76 and access control module 78. In this regard, processor 80 provides processing capability to allow access control filter logic 84 to determine if one or more access control privileges 22 apply to an access attempt. The processor 80 may additionally include processing subsystems 88 embodied that are operable to enable the functionality of network device 72 and the operability of the network device on wireless network 18. The processing subsystems 88 may include components that provide environmental or state information related to wireless device 12 to the access control module 82. For example, in some aspects, access control privileges 22 may include attributes 23 that provide for location-based or time-based access control. In such aspects, the processing subsystems 88 may include position determining subsystem 90, such as a Global Positioning System (GPS) subsystem or the like, operable for determining the geographic location of wireless communication device 12 and/or a clock subsystem 92 operable for determining the time at which an access attempt occurs. Additional subsystems (not shown) may also be include as needed depending on the environmental and/or state conditions required to determine a predefined access control attribute 22.

It should be noted that while FIG. 2 depicts the access control database 20 residing in network device 14 and the access control filter logic 84 residing in network device 72, in other aspects it may be feasible to incorporate access control attribute database 20 and access control filter logic 84 in a single network device/entity.

The system 70 of FIG. 2 also includes a wireless communication device 12 that includes a communications module 38 and a computing platform 36 having a memory 40 and a processor 42. Communication module 36 is operable to initiate and receive service access attempts, as well as, notifications from network device 72 informing that service access has been denied or limited according to access control privileges. Memory 40 may include an access control module 44 that includes an access control user interface module 54 operable for providing wireless communication device user 56 with an interface, such as a display interface or the like, that allows user 56 to view and/or configure access control privileges 22. Configuring the access control privileges may include, but is not limited to, inputting, modifying, suspending and/or activating the access control privileges. It should be noted that the access control privileges 22 may be preconfigured to allow for user modification, suspension or the like or, alternatively, certain access control privileges 22 may be preconfigured such that user is not authorized to make changes to the access control privileges. For example, if the access control privileges are configured by a third party entity, such as a parent or an employer, the privileges may be configured such that user 56 is not authorized to make changes, however; if the privileges have been configured by user 56, then the privileges may be configured to allow for modification, suspension or the like. Additionally, access control interface module 54 may provide for a user interface, such as visual display, that notifies user 56 when an access control attribute is being implemented to control access, such as when user 56 is attempting to access a service 48, content 50 or an application 52. In addition to providing notification that access is being prohibited or limited the user interface may provide for the user to modify or temporarily suspend the access control for this access attempt.

In certain aspects, such as when system 70 is limited to access control over networked services, networked content and/or networked applications and provides no access control for content and/or applications that reside on the wireless device, access control filter logic 46 may be limited to network device 72. However, in those aspects in which the system additionally provides access control over content 50 and 52 applications residing on the wireless device, the access control module may, in those aspects, additionally include access control filter logic 46 operable for determining if access control privileges 22 apply to attempts to access locally stored content 50 and or applications 52. Thus, in those applications in which the access control module includes access control filter logic 46, the logic 46 is operable to determine if one or more access control privileges 22 apply to an access attempt associated with, content 50 and/or application 52. The access control privileges 22 stored in memory 40 may be received from user 56 via access control user interface module 54 or received via communication module 38 from network device 14. The access control privileges 22 may be configured to prohibit or otherwise limit access to content 50 and/or any application 52 in terms of any preconfigured access control attribute. Control attributes may include, but are not limited to, content type, service type, environmental attributes, such as geographical location of the wireless communication device, time of day, time of week and the like. The access control privileges may be configured such that they control access to more than one content 50 item and/or more than one application 52 and, in some aspects, all of the content 50 and/or applications 52 residing on and/or accessible to the wireless communication device 12.

The computer platform 36 of wireless communication device 12 includes processor 42 that is operable to provide processing capability to communication module 36 and access control module 44. In this regard, processor 42 provides processing capability to allow access control filter logic 46 to determine if one or more access control privileges 22 apply to an access attempt. The processor 42 may additionally include processing subsystems 58 embodied that are operable to enable the functionality of communication device 12 and the operability of the communication device on wireless network 18. The processing subsystems 58 may include components that provide environmental and/or state information to the access control module 44. For example, in some aspects, access control privileges 22 may include attributes 23 that provide for location-based or time-based access control. In such aspects, the processing subsystems 58 may include position determining subsystem 60, such as a Global Positioning System (GPS) subsystem or the like, operable for determining the geographic location of the device and/or a clock subsystem 62 operable for determining the time at which an access attempt occurs. Additional subsystems (not shown) may also be include as needed depending on the environmental and/or state conditions required to determine a predefined access control attribute 22.

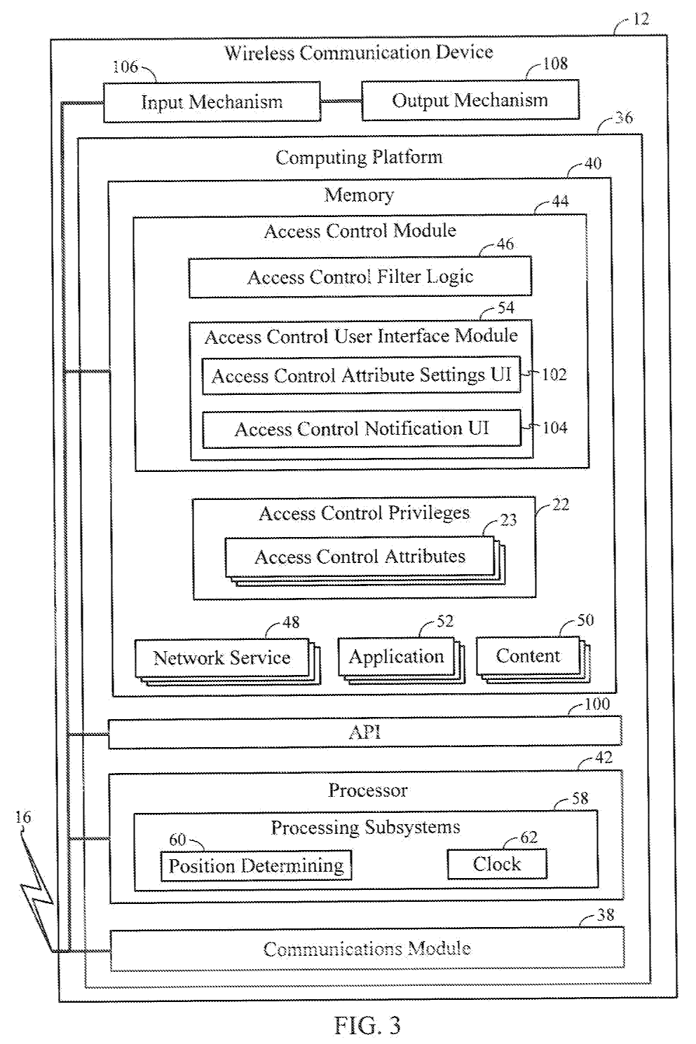

Referring to FIG. 3, according to one aspect, a detailed block diagram representation of wireless communication device 12 is depicted. The wireless communication device 10 may include any type of computerized, communication device, such as cellular telephone, Personal Digital Assistant (PDA), two-way text pager, portable computer, and even a separate computer platform that has a wireless communications portal, and which also may have a wired connection to a network or the Internet. The wireless communication device can be a remote-slave, or other device that does not have an end-user thereof but simply communicates data across the wireless network, such as remote sensors, diagnostic tools, data relays, and the like. The present apparatus and methods can accordingly be performed on any form of wireless communication device or wireless computer module, including a wireless communication portal, including without limitation, wireless modems, PCMCIA cards, access terminals, desktop computers or any combination or sub-combination thereof.

The wireless communication device 12 includes computer platform 36 that can transmit data across a wireless network, and that can receive and execute routines and applications. Computer platform 36 includes memory 40, which may comprise volatile and nonvolatile memory such as read-only and/or random-access memory (RAM and ROM), EPROM, EEPROM, flash cards, or any memory common to computer platforms. Further, memory 40 may include one or more flash memory cells, or may be any secondary or tertiary storage device, such as magnetic media, optical media, tape, or soft or hard disk.

Further, computer platform 36 also includes processor 42, which may be an application-specific integrated circuit (“ASIC”), or other chipset, processor, logic circuit, or other data processing device. Processor 42 or other processor such as ASIC may execute an application programming interface (“API”) layer 100 that interfaces with any resident programs, such as access control module 44, stored in the memory 40 of the wireless device 12. API 100 is typically a runtime environment executing on the respective wireless device. One such runtime environment is Binary Runtime Environment for Wireless® (BREW®) software developed by Qualcomm, Inc., of San Diego, Calif. Other runtime environments may be utilized that, for example, operate to control the execution of applications on wireless computing devices.

Processor 42 includes various processing subsystems 58 embodied in hardware, firmware, software, and combinations thereof, that enable the functionality of communication device 12 and the operability of the communication device on a wireless network. For example, processing subsystems 58 allow for initiating and maintaining communications, and exchanging data, with other networked devices. In aspects in which the communication device is defined as a cellular telephone the communications processor 42 may additionally include one or a combination of processing subsystems 58, such as: sound, non-volatile memory, file system, transmit, receive, searcher, layer 1, layer 2, layer 3, main control, remote procedure, handset, power management, digital signal processor, messaging, call manager, Bluetooth® system, Bluetooth® LPOS, position engine, user interface, sleep, data services, security, authentication, USIM/SIM, voice services, graphics, USB, multimedia such as MPEG, GPRS, etc (all of which are not individually depicted in FIG. 2 for the sake of clarity). For the disclosed aspects, processing subsystems 58 of processor 42 may include any subsystem components that interact with the access control module 44, such as position determining subsystem 60 and/or clock subsystem 62.

Computer platform 36 additionally includes communications module 38 embodied in hardware, firmware, software, and combinations thereof, that enables communications among the various components of the wireless communication device 12, as well as between the communication device 12 and wireless network 18. In described aspects, the communication module 38 enables the communication of all correspondence between wireless communication device 12, the network device 14 and network device 72. The communication module 68 may include the requisite hardware, firmware, software and/or combinations thereof for establishing a wireless network communication connection. In some aspects, the communication module may be operable to receive access control privileges 22 communicated from a network device and to internally communicate the access control privileges 22 to memory 40.

The memory 40 of computer platform 36 includes access control module 44, which may be operable to control access to a service, content and/or application based on preconfigured access control privileges 22. As previously noted, in alternate aspects, access control may be determined and implemented at a network device. The access control module 44 may include access control filter logic 46 that is operable to determine if one or more access control privileges 22 apply to an access attempt associated with service 48, content 50 and/or application 52. The access control privileges 22 may be configured to prohibit or otherwise limit access to a service 48, content 50 and/or any application 52 in terms of any preconfigured access control attribute, which define the access control privileges 22. Control attributes 23 may include, but are not limited to, from whom communication may be received, from whom communication may be place, content type, service type, communication length (in time), environmental attributes, such as geographical location of the wireless communication device, time of day, time of week and the like. The access control privileges 22 may be configured such that they control access to more than one service 48 and, in some aspects, all of the services 48 available on the wireless communication device. In this regard, the access control privileges may be configured such that they control access to multiple content 50 items and/or multiple applications 52 and, in some aspects, all of the content 50 and/or applications 52 residing on and/or accessible to the wireless communication device 12. In some aspects, in which the access control privileges are not stored locally in memory 22, the access control module 44 may be required to initiate wireless communication to retrieve the applicable access control privileges from a network database.

Additionally, access control module 44 may include an access control user interface module 54 that includes access control settings user interface 102 and access control notification user interface 104. The access control settings interface 102 is operable for providing a user interface, such as a display interface or the like, that allows a user to view and/or configure access control privileges 22. Configuring the access control privileges may include, but is not limited to, inputting, modifying, suspending and/or activating the access control privileges. It should be noted that the access control privileges 22 may be preconfigured to allow for user modification, suspension or the like or, alternatively, certain access control privileges 22 may be preconfigured such that user is not authorized to make changes to the access control privileges. The access control notification user interface 104 is operable to provide for a user interface, such as visual display, that notifies the user when an access control attribute is being implemented to control access, such as when the user is attempting to access a service 48, content 50 or an application 52. In addition to providing notification that access is being prohibited or limited access control notification user interface 104 may provide for the user to modify or temporarily suspend the access control for this access attempt.

Additionally, wireless communication device 12 has input mechanism 106 for generating inputs into communication device, and output mechanism 108 for generating information for consumption by the user of the communication device. For example, input mechanism 106 may include a mechanism such as a key or keyboard, a mouse, a touch-screen display, a microphone, etc. In certain aspects, the input mechanisms 106 provides for user input to interface with an application, such as access control module 44 on the communication device. Further, for example, output mechanism 108 may include a display, an audio speaker, a haptic feedback mechanism, etc. In the illustrated aspects, the output mechanism 108 may include a display operable to display access control user interfaces.

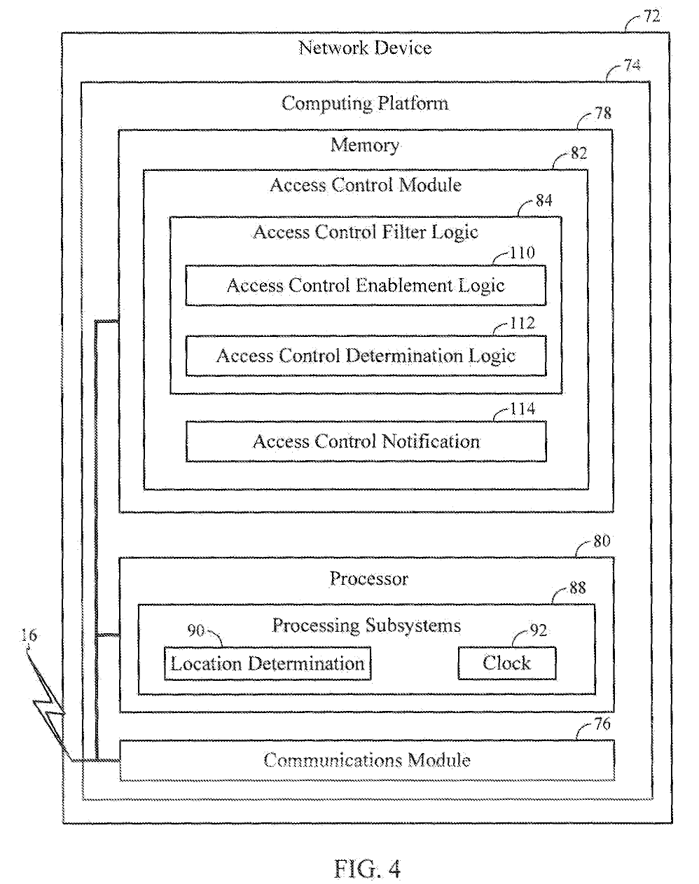

Referring to FIG. 4, according to another aspect, a detailed block diagram is illustrated of a network device 72, which is operable for determining and implementing access control. The network device 72 may comprise at least one of any type of hardware, server, personal computer, mini computer, mainframe computer, or any computing device either special purpose or general computing device. Further, the modules and applications described herein as being operated on or executed by the network device 72 may be executed entirely on the network device 72 or alternatively, in other aspects, separate servers or computer devices may work in concert to provide data in usable formats to parties, and/or to provide a separate layer of control in the data flow between the communication device 12 and the modules and applications executed by network device 72.

The network device 72 includes computer platform 74 that can transmit and receive data across wireless network 18, and that can execute routines and applications. Computer platform 74 includes a memory 78, which may comprise volatile and nonvolatile memory such as read-only and/or random-access memory (RAM and ROM), EPROM, EEPROM, flash cards, or any memory common to computer platforms. Further, memory 78 may include one or more flash memory cells, or may be any secondary or tertiary storage device, such as magnetic media, optical media, tape, or soft or hard disk.

Further, computer platform 74 also includes a processor 80, which may be an application-specific integrated circuit (“ASIC”), or other chipset, logic circuit, or other data processing device. Processor 80 includes various processing subsystems 88 embodied in hardware, firmware, software, and combinations thereof, that enable the functionality of network device 72 and the operability of the network device on a wireless network. For example, processing subsystems 88 allow for initiating and maintaining communications, and exchanging data, with other networked devices. For the disclosed aspects, processing subsystems 88 of processor 80 may include any subsystem components that interact with the access control module 82, such as position determining subsystem 90 and/or clock subsystem 92.

The computer platform 74 further includes a communications module 76 embodied in hardware, firmware, software, and combinations thereof, that enables communications among the various components of network device 72, as well as between the network device 72, wireless communication devices 12 and network database device 14. The communication module 76 may include the requisite hardware, firmware, software and/or combinations thereof for establishing a wireless communication connection. The communication module 76 is operable to receive access attempts from wireless devices, such as wireless device 12, query databases for access control privileges related to the access attempt and notify the device attempting access if control is necessary.

The memory 78 of network device 72 also includes an access control module 82 including access control filter logic 84. The access control filter logic 84 may include access control enablement logic 110 and access control determination logic 112. The access control enablement logic 110 is operable for determining if the wireless device that is attempting/receiving service access has access control enabled. The access control determination logic 112 is operable for determining if one or more access control privileges 22 apply to an access attempt. In this regard, the access control module 82 will query the access control database, either a locally stored database or an external database, to determine if the access attempt has associated access control privileges 22. The access control privileges 22 may be configured to prohibit or otherwise limit access to a networked service in terms of any preconfigured access control attribute 23, which define the access control privilege 22. Control attributes may include, but are not limited to, from whom communication may be received, to whom communication may be placed, content type, service type, environmental attributes, such as geographical location of the wireless communication device, time of day, time of week and the like. The access control privileges 22 may be configured such that they control access to more than one service 24 and, in some aspects, all of the services 48 available on the wireless communication device.

The access control module 82 of network device 72 may additionally include an access control notification routine 114 that is operable for notifying the wireless communication if access is prohibited or limited. The notification 114 that is communicated to the wireless device 12 may be displayed to the user and may optionally provide for the user to suspend and/or modify the access control to override access control for this particular access attempt. It should be noted that suspending and/or modify the access control may only be available if access control privileges have been preconfigured to allow for such suspension and/or modification, typically at the discretion of the entity defining the access control privileges.

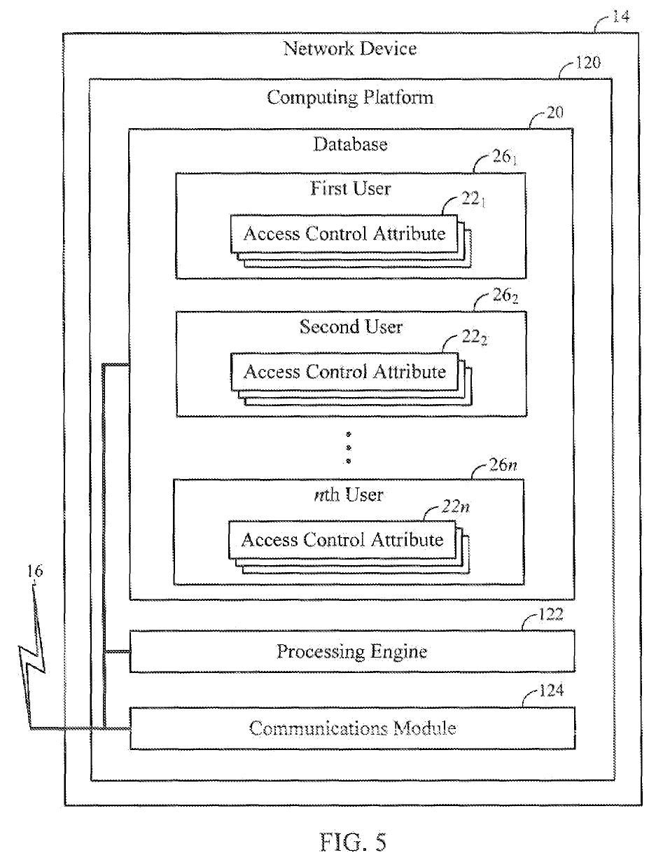

Referring to FIG. 5, according to another aspect, a detailed block diagram is presented of network device 14, which is operable to receive and store access control privileges 22. The network device 14 may comprise at least one of any type of hardware, server, personal computer, mini computer, mainframe computer, or any computing device either special purpose or general computing device. Further, the modules and applications described herein as being operated on or executed by the network device 14 may be executed entirely on the network device 14 or alternatively, in other aspects, separate servers or computer devices may work in concert to provide data in usable formats to parties, and/or to provide a separate layer of control in the data flow between the communication device 12 and the modules and applications executed by network device 14.

The network device 14 includes computer platform 120 that can transmit and receive data across wireless network 18, and that can execute routines and applications. Computer platform 120 includes a database 20, which may comprise volatile and nonvolatile memory such as read-only and/or random-access memory (RAM and ROM), EPROM, EEPROM, flash cards, or any memory common to computer platforms. Further, database 20 may include one or more flash memory cells, or may be any secondary or tertiary storage device, such as magnetic media, optical media, tape, or soft or hard disk. Further, computer platform 120 also includes a processor 122, which may be an application-specific integrated circuit (“ASIC”), or other chipset, logic circuit, or other data processing device.

The computer platform 120 further includes a communications module 124 embodied in hardware, firmware, software, and combinations thereof, that enables communications among the various components of network device 14, as well as between the network device 14, wireless communication devices 12 and network filter device 72. The communication module 124 may include the requisite hardware, firmware, software and/or combinations thereof for establishing a wireless communication connection. The communication module 124 is operable to receive access control privileges from third party entity/users 26 and communicate the access control privileges to the wireless communication device 12 and/or network filter device

The database 20 of network device 14 includes access control privileges 22 each with one or more associated access control attributes 23. Each privilege or set of privileges is associated with a wireless device user and/or a wireless device. In the illustrated aspect of FIG. 5, first user 26₁ has associated access control privileges 22₁, second user 26₂ has associated access control privileges 22₂ and the nth user 26ₙ has associated access control parameters 22ₙ, where n is a positive integer representing a given total number of users. The access control privileges 22 may be configured to prohibit or otherwise limit access to a service, content and/or application in terms of any preconfigured access control attribute 23, which define access control privileges 22. Control attributes 23 may include, but are not limited to, from whom communication may be received, from whom communication may be placed, content type, service type, communication length (in time), environmental attributes, such as geographical location of the wireless communication device, time of day, time of week and the like. The access control privileges 22 may be configured such that they control access to multiple services, content and/or applications and, in some aspects, all of the services, content and/or applications available on the wireless communication device.

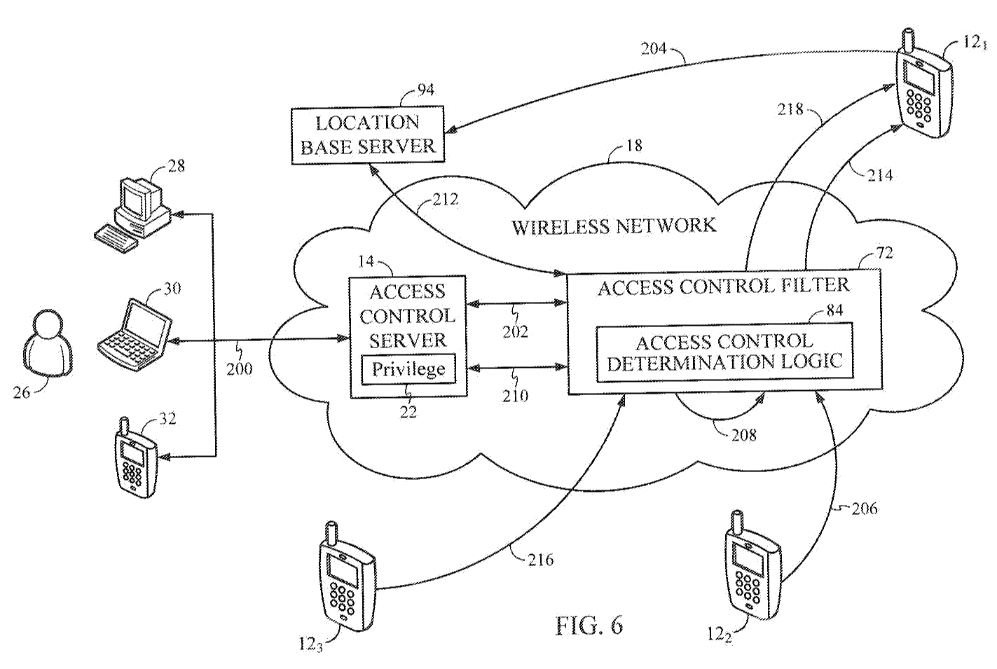

FIGS. 6-9 provide block diagrams that assist in describing various method aspects, in which access control functionality is performed at the network level. In the FIG. 6 aspect, a communication call access attempt is denied based on an access control privilege that prohibits receiving access from a specified wireless device at specified geographic locations. At Event 200, a third party entity/user (26) logs on to a web service that includes access control server (14) and defines the access control privileges (22) for a specified wireless device (12₁). The third party entity/user (26) may use any communication device, such as PC (28), laptop (30) and/or wireless device (32), to log on and define the access control privileges (22). Thus, the connection between the communication device (28, 30, 32) and the access control server (14) may be wired or wireless. The defined access control privileges (22) include a privilege that prohibits the wireless device (12₁) from receiving calls from a specified wireless device (12₂) when the device (12₁) is located at a specified location. For example, the defined access control privilege may prohibit calls from a friend, the user of device (12₂) when the device (12₁) is located at school.

At Event 202, the access control server (14) notifies the network filter device (72) that the specified wireless device (12₁) has access control functions enabled. In some aspects, the notification may be communicated to the network filter device (72) once the access control privileges (22) have been defined and stored at the access control server (14) or, alternatively, the network filter device (72) may query the access control server (14) upon receiving an access attempt to insure that the function is enabled at the time the access attempt is received.

At Event 204, the wireless communication device (12₁) periodically updates the location base server (94) with location information; as such the network filter device (72) can query the location base server (94) to determine the location of the wireless communication device (12₁).

At Event 206, a wireless device (12₂) attempts to call the wireless communication device (12₁) via the wireless communication network. At Event 208, the access control filter (72) intercepts the call request. At this point, the access control filter may check to verify that wireless device (12₁) has the access control functionality enabled. As previously noted this may entail verifying enablement in a local database or querying the access control server (14) to verify enablement.

Once enablement is verified, at Event 210, the access control filter device (72) queries the access control server (14) to determine if one or more access control privileges (22) apply to the access attempt. In this particular example, a privilege is defined that prohibits receiving call from the wireless device (12₂) when the wireless device (12₁) is located at a specified location. At Event 212, the access control filter device (72) queries the location base server (94) to determine the current location of wireless device (12₁) based on a determined access control privilege (22) controlling access by wireless device (12₂) based on the location of wireless device (12₁).

Once the logic (84) within access control filter device (72) determines that the wireless device (12₁) is located at a prescribed location, as defined by an access control attribute, which prohibits communication with wireless device (12₂), at Event 214, the access attempt is denied and a notification is sent to the wireless device (12₁) alerting the user that access has been denied and, optionally, allowing the user to override or modify the access control.

At Event 216, wireless device (123) attempts to call the wireless communication device (12₁) via the wireless communication network. At Event 208, the access control filter (72) intercepts the call request and verifies access control enablement. Once enablement is verified, at Event 210, the access control filter device (72) queries the access control server (14) to determine if one or more access control privileges (22) apply to the access attempt. In this particular example, no access control privileges (22) are associated with wireless device (12₃). Therefore, at Event 218, the wireless communication call request is allowed to go through to the wireless communication device (12₁).

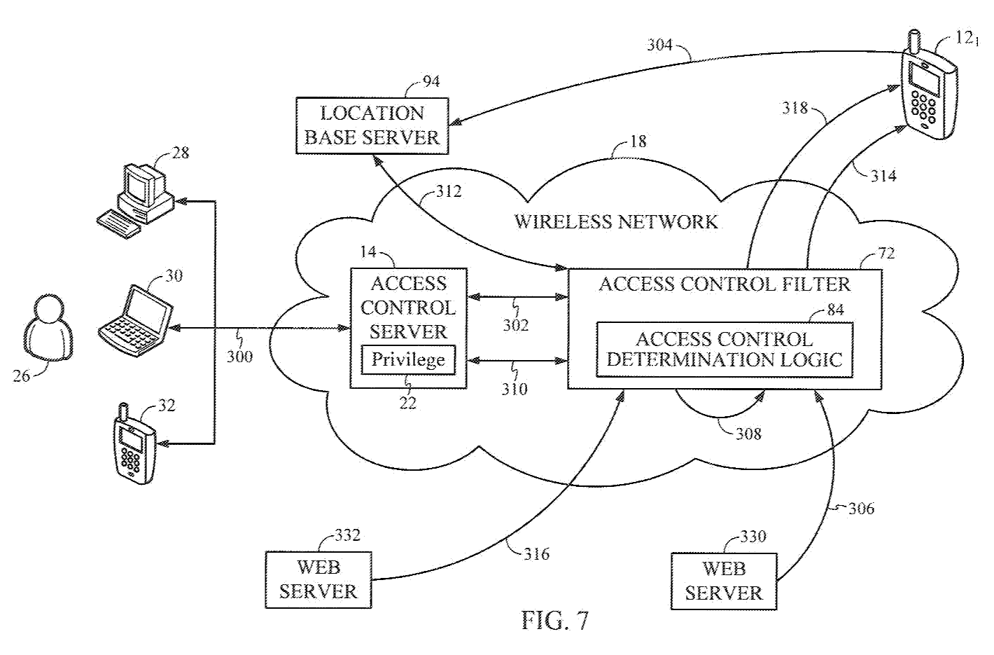

Referring to FIG. 7, according to one aspect, a data service access attempt is denied based on an access control privilege that prohibits receiving access from a specified wireless device at specified geographic locations. At Event 300, a third party entity/user (26) logs on to a web service that includes access control server (14) and defines the access control privileges (22) for a specified wireless device (12). The defined access control privileges (22) include a privilege that prohibits access to a web server (330) when the device (12A) is located at a specified location. For example, the defined access control privilege (22) may prohibit access to web server/service (330), when the device (12) is located at school.

At Event 302, the access control server (14) notifies the network filter device (72) that the specified wireless device (12) has access control functions enabled. At Event 304, the wireless communication device (12) periodically updates the location base server (94) with location information; as such the network filter device (72) can query the location base server (94) to determine the location of the wireless communication device (12).

At Event 306, a web server (330) attempts to send data to wireless communication device (12) via the wireless communication network. At Event 308, the access control filter (72) intercepts the data communication. At this point, the access control filter may check to verify that wireless device (12) has the access control functionality enabled. As previously noted this may entail verifying enablement in a local database or querying the access control server (14) to verify enablement.

Once enablement is verified, at Event 310, the access control filter device (72) queries the access control server (14) to determine if one or more access control privileges (22) apply to the access attempt. In this particular example, a privilege is defined that prohibits receiving data from web server/service (330) when the wireless device (12) is located at a specified location. At Event 312, the access control filter device (72) queries the location base server (94) to determine the current location of wireless device (12) based on a determined access control privilege (22) controlling web server/service (330) access based on the location of wireless device (12).

Once the logic (84) within access control filter device (72) determines that the wireless device (12) is located at a prescribed location, as defined by an access control attribute, which prohibits receiving data from web server (330), at Event 314, the access attempt is denied and a notification is sent to the wireless device (12) alerting the user that access has been denied and, optionally, allowing the user to override or modify the access control.

At Event 316, web server/service (332) attempts to send data to the wireless communication device (12) via the wireless communication network. At Event 308, the access control filter (72) intercepts the data transmission and verifies access control enablement. Once enablement is verified, at Event 310, the access control filter device (72) queries the access control server (14) to determine if one or more access control privileges (22) apply to the access attempt. In this particular example, no access control privileges (22) are associated with web server/service (332). Therefore, at Event 318, the data being transmitted from web server/service (332) is allowed to go through to the wireless communication device (12).

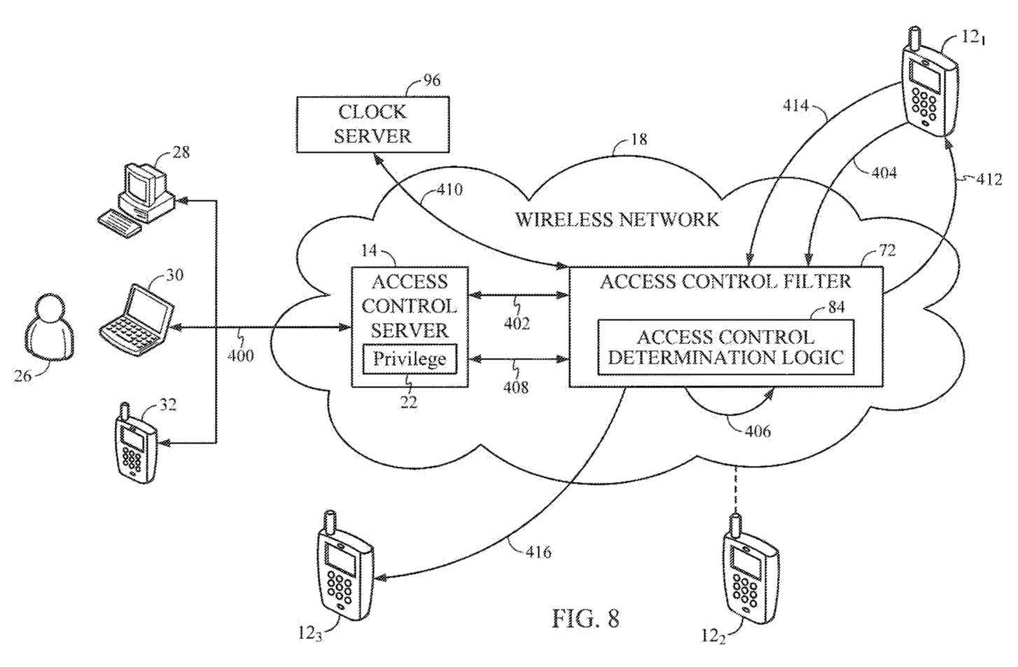

Referring to FIG. 8, according to another aspect, a communication call attempt is denied based on an access control privilege that prohibits receiving access from a specified wireless device at specified time. At Event 400, a third party entity/user (26) logs on to a web service that includes access control server (14) and defines the access control privileges (22) for a specified wireless device (12₁). The third party entity/user (26) may use any communication device, such as PC (28), laptop (30) and/or wireless device (32), to log on and define the access control privileges (22). The defined access control privileges (22) include an access control attribute that prohibits the wireless device (12₁) from placing calls from a specified wireless device (12₂) at a specified time. For example, the defined access control attribute may prohibit calls from a friend, the user of device (12₂) during normal school hours. At Event 402, the access control server (14) notifies the network filter device (72) that the specified wireless device (12₂) has access control functions enabled.

At Event 404, wireless device (12₁) attempts to call wireless communication device (12₂) via the wireless communication network. At Event 406, the access control filter (72) intercepts the call request. At this point, the access control filter may check to verify that wireless device (12₁) has the access control functionality enabled. As previously noted this may entail verifying enablement in a local database or querying the access control server (14) to verify enablement.

Once enablement is verified, at Event 408, the access control filter device (72) queries the access control server (14) to determine if one or more access control privileges (22) apply to the access attempt. In this particular example, a privilege is defined that prohibits wireless device (12₁) from placing calls to wireless device (12₂) at a specified time. At Event 410, the access control filter device (72) queries the time server (96) or an internal clock component to determine the current time based on a determined access control privilege (22) controlling access by wireless device (12₁) based on current time.

Once the logic (84) within access control filter device (72) determines that the wireless device (12₁) is attempting a call at the prescribed time, as defined by an access control privilege, which prohibits placing a call to wireless device (12₂), at Event 412, the access attempt is denied and a notification is sent to the wireless device (12₁) alerting the user that access has been denied and, optionally, allowing the user to override or modify the access control.

At Event 414, wireless device (12₁) attempts to call the wireless communication device (12₃) via the wireless communication network. At Event 208, the access control filter (72) intercepts the call request and verifies access control enablement. Once enablement is verified, at Event 210, the access control filter device (72) queries the access control server (14) to determine if one or more access control privileges (22) apply to the access attempt. In this particular example, no access control privileges (22) are associated with wireless device (12₃) or the call is being placed outside of any limits prescribed within the access control privileges (22). Therefore, at Event 416, the wireless communication call request is allowed to go through to the wireless communication device (12₃).

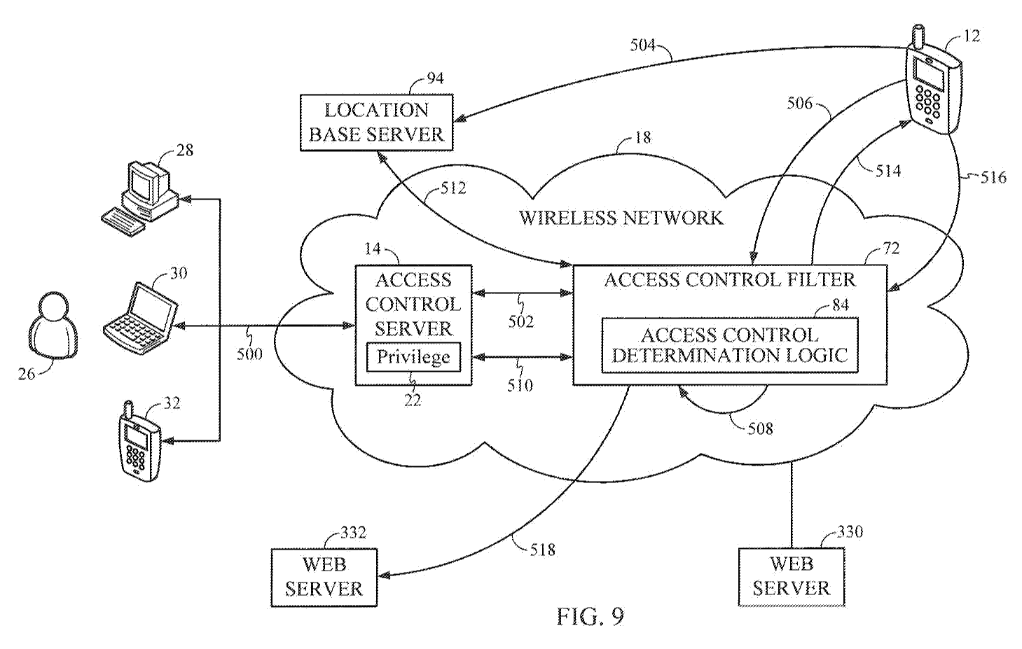

Referring to FIG. 9, according to another aspect, a web server access attempt is denied based on an access control privilege that prohibits accessing the web server when wireless device (12) is located at a specified location. At Event 500, a third party entity/user (26) logs on to a web service that includes access control server (14) and defines the access control privileges (22) for a specified wireless device (12). The third party entity/user (26) may use any communication device, such as PC (28), laptop (30) and/or wireless device (32), to log on and define the access control privileges (22). The defined access control privileges (22) includes a privilege that prohibits the wireless device (12) from accessing a specified web server (330) when the wireless device (12) is located at a specified location. For example, the defined access control privilege (22) may prohibit the wireless device (12) from accessing web server (330) when the wireless device (12) is located at an employer's site.

At Event 502, the access control server (14) notifies the network filter device (72) that the specified wireless device (12) has access control functions enabled. At Event 504, the wireless communication device (12) periodically updates the location base server (94) with location information; as such the network filter device (72) can query the location base server (94) to determine the location of the wireless communication device (12).

At Event 506, wireless device (12) attempts to access web server (330) via the wireless communication network. At Event 508, the access control filter (72) intercepts the call request. At this point, the access control filter may check to verify that wireless device (12) has the access control functionality enabled. As previously noted this may entail verifying enablement in a local database or querying the access control server (14) to verify enablement.

Once enablement is verified, at Event 510, the access control filter device (72) queries the access control server (14) to determine if one or more access control privileges (22) apply to the access attempt. In this particular example, a privilege is defined that prohibits wireless device (12) from accessing web server (330) when the device (12) is located at a specified location. At Event 512, the access control filter device (72) queries the location based server (94) to determine the current location of the wireless device (12) based on a determined access control privilege (22) controlling access by wireless device (12) based on current location.

Once the logic (84) within access control filter device (72) determines that the wireless device (12) is attempting to access the web server (330) at the prescribed time, as defined by an access control privilege (22), at Event 514, the access attempt is denied and a notification is sent to the wireless device (12) alerting the user that access has been denied and, optionally, allowing the user to override or modify the access control.

At Event 516, wireless device (12) attempts access web server (332) via the wireless communication network. At Event 508, the access control filter (72) intercepts the call request and verifies access control enablement. Once enablement is verified, at Event 510, the access control filter device (72) queries the access control server (14) to determine if one or more access control privileges (22) apply to the access attempt. In this particular example, no access control privileges (22) are associated with web server (332) or the call is being placed outside of any location limits prescribed within the access control privileges (22). Therefore, at Event 518, the access request to web server (332) is allowed to go through.

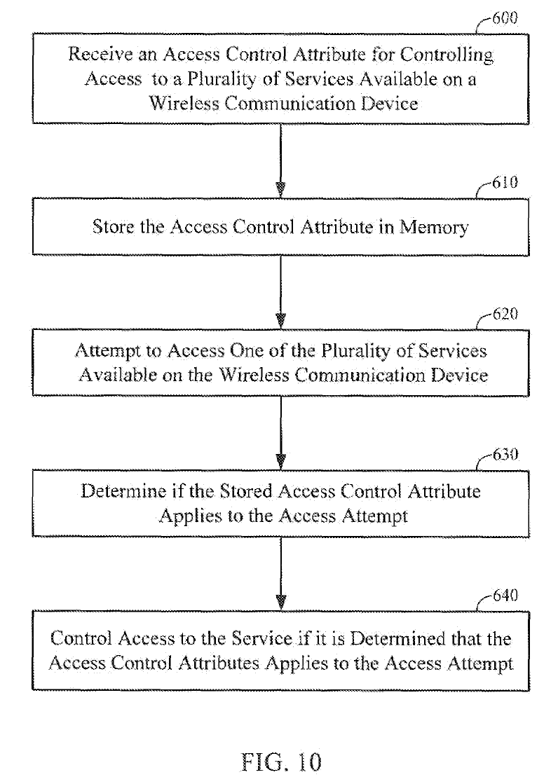

FIG. 10 is a flow diagram of a method for controlling access on a wireless communication device, according to an aspect. At Event 600, one or more access control privileges, as defined by access control attributes, are received that control access to a plurality of wireless network services available on the wireless device. The access control privileges may be received at the wireless device that is having accessed controlled, such as by user interaction with a user interface that provides for defining and receiving access control privileges. Alternatively, the access control privileges may be received at a network device, such as an access control database device that is accessible through an Internet web site, a private network portal or the like. Receiving access control privileges at a network device allows for an authorized third party entity, such as a parent, employer or the like, to define access control privileges and, thus, control the access afforded a wireless device. In addition to controlling access to network services, the access control privileges can control access to content and/or applications residing on the wireless device, such as images, text, audio and/or video player applications and the like.

The access control privileges may control more than one and, in some aspects, all of the services available to the wireless device and/or the content and applications available on the wireless communication device. Examples of access control attributes include, but are not limited to, geographic location of the wireless communication device, time, type of service, type of content, communication length (in time), to whom or from whom communication or data may be transmitted to or from and the like. Controlling from whom and to whom communication may be transmitted to or from may include, but is not limited to, defining a controlled URL addresses, Short Message Service (SMS) addresses, Mobile Identification Numbers (MINs)/telephone numbers and the like. Access control may include prohibiting access or limiting the access based on the defined access control privileges.

At Event 610, the access control privileges are stored in memory. If the access control privileges are received at the wireless communication device, storage will typically occur locally at the wireless communication device, however, if storage capacity at the wireless device is limited or if back-up storage is desired the access control privileges may be uploaded to a network device for storage purposes. If the access control privileges are received at a network device, storage will typically occur a network device database. Additionally, if access control functionality is wireless device-based, the privileges may additionally be stored at the wireless device level.

At Event 620, an attempt is made to access a service available on the wireless communication device. Alternatively, in those aspects in which access control is also provided to content and applications on the wireless device, an attempt to access content or an application available on the wireless device may also be made. An access attempt may include attempting to place a communication call, attempting to accessing a network device, such as a web server or database, attempting to receive a communication call or attempting to receive network data communicated from a network device, such as a web server or database.

Based on the access attempt, at Event 630, a determination is made as to whether the access control privileges apply to the access attempt. The determination may occur at the wireless device or the determination may occur at a network device, such as an access control filter device or the like. The determination is accomplished by comparing access attempt attributes to access control privileges. The access attempt attributes may include the current location of the wireless device, the current time, the address of the party to whom or from whom communication is being attempted and the like. If the determination is accomplished at the wireless communication device, the device will likely query the locally stored access control privileges to determine if access control privileges are applicable. If the determination is accomplished at a network device, the device will likely query an external access control database to determine if access control privileges are applicable.

At Event 640, if a determination is made that one or more access control privileges apply to the access attempt, access is controlled according to the predefined access control attribute. Controlling access may involve prohibiting access or limiting access as defined by the control attributes. Additionally, the wireless communication device user may be notified that access is being controlled by providing a displayable notification to the user. The notification may, if authorized, provide for the user to suspend or modify the access control.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes or instructions on a machine-readable medium and/or computer readable medium, which may be embodied in a computer program product.

While the foregoing disclosure shows illustrative aspects and/or embodiments, it should be noted that various changes and modifications could be made herein without departing from the scope of the described aspects and/or embodiments as defined by the appended claims. Furthermore, although elements of the described embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

Thus, present aspects provide for methods, devices, systems and computer program products for controlling access to services, content, applications and the like on a wireless communication device. In one aspect, wireless communication device-wide access control is provided such that unified access control may exist on the device; providing access control to more than one, and in some instances all, of the services and/or applications that are accessible on the device. Additionally, aspects provide for limiting or prohibiting access based on numerous access control attributes, such as content type, service type, location of the device, time or any other device environmental characteristic. The methods, devices, systems and computer program products for content access control may be executed on the wireless communication device or they may be executed within the wireless network.

Many modifications and other aspects will come to mind to one skilled in the art to which this invention pertains having the benefit of the teachings presented in the foregoing descriptions and the associated drawings. Therefore, it is to be understood that the aspect is not to be limited to the specific aspects disclosed and that modifications and other aspects are intended to be included within the scope of the appended claims. Although specific terms are employed herein, they are used in a generic and descriptive sense only and not for purposes of limitation. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for controlling access on a wireless communication device, comprising:
receiving at least one access control privilege that includes at least one access control attribute and is associated with a wireless communication device, wherein each access control privilege controls access to a plurality of services available on the wireless communication device;
storing the at least one access control privilege in memory;
receiving a request to access one of the plurality of services available on the wireless communication device; and
controlling access to the service if it is determined that the at least one stored access control privilege applies to an access request.

2. The method of claim 1, wherein receiving at least one access control privilege that includes at least one access control attribute further defines the access control attribute as the geographic location of the wireless communication device.

3. The method of claim 1, wherein receiving at least one access control privilege that includes at least one access control attribute further defines the access control attribute as a time period.

4. The method of claim 1, wherein receiving at least one access control privilege that includes at least one access control attribute further defines the access control attribute as chosen from the group consisting of to whom communication may be transmitted, from whom communication may be received, a type of service, type of content received from a service, environmental conditions, state conditions and any combination of the aforementioned attributes.

5. The method of claim 1, wherein each access control privilege further controls access to a plurality of applications available on the wireless communication device.

6. The method of claim 1, wherein each access control privilege further controls access to a plurality of content available on the wireless communication device.

7. The method of claim 1, wherein receiving at least one access control privilege further comprises receiving, at the wireless communication device, at least one access control privilege.

8. The method of claim 1, wherein receiving at least one access control privilege further comprises receiving, at a network interface, at least one access control privilege.

9. The method of claim 1, wherein storing the at least one access control attribute in memory further comprises storing the at least one access control attribute in memory in the wireless communication device.

10. The method of claim 1, wherein storing the at least one access control attribute in memory further comprises storing the at least one access control attribute in network device memory.

11. The method of claim 1, further comprising enabling an access control function for the wireless communication device.

12. The method of claim 11, wherein enabling the access control function further comprises notifying a network entity that the access control function is enabled for the wireless communication device.

13. The method of claim 11, further comprising determining if the access control function is enabled prior to determining if the at least one stored access control attribute applies to the access attempt.

14. The method of claim 1, wherein controlling access to the service if it is determined that the at least one stored access control privilege applies to an access request further comprises determining, at the wireless communication device, if the at least one stored access control privilege applies to the access request.

15. The method of claim 1, wherein controlling access to the service if it is determined that the at least one stored access control privilege applies to an access request further comprises determining, at a network device, if the at least one stored access control privilege applies to the access request.

16. The method of claim 1, wherein receiving at least one access control privilege further defines receiving as chosen from the group consisting of user-inputting, wireless device manufacturer-inputting, and network service provider-inputting.

17. The method of claim 1, wherein controlling access to the service further comprises prohibiting access to the service.

18. The method of claim 1, wherein controlling access to the service further comprises limiting access to the service.

19. The method of claim 18, wherein limiting access to the service further defines limiting access as chosen from the group consisting of limiting a time for access to the service, limiting a geographic location for access to the service, limiting the type of content accessed, limiting the type of network services accessed, limiting to whom a communication may be transmitted and limiting from whom communication may be received.

20. At least one processor configured to control access on a wireless communication device, comprising:
a first module for receiving at least one access control privilege that includes at least one access control attribute and is associated with a wireless communication device, wherein each access control privilege controls access to a plurality of services available on the wireless communication device;
a second module for storing the at least one access control privilege in memory;
a third module for receiving a request to access one of the plurality of services available on the wireless communication device; and
a fourth module for controlling access to the service if it is determined that the at least one stored access control privilege applies to an access request.

21. A computer program product, comprising:
a computer-readable medium comprising:
a first set of codes for causing a computer to receive at least one access control privilege that includes at least one access control attribute and is associated with a wireless communication device, wherein each access control privilege controls access to a plurality of services available on the wireless communication device;
a second set of codes for causing a computer to store the at least one access control privilege in memory;
a third set of codes for causing a computer to receive a request to access one of the plurality of services available on the wireless communication device; and
a fourth set of codes for causing a computer to control access to the service if it is determined that the at least one stored access control privilege applies to an access request.

22. A device, comprising:
means for receiving at least one access control privilege that includes at least one access control attribute and is associated with a wireless communication device, wherein each access control privilege controls access to a plurality of services available on the wireless communication device;
means for storing the at least one access control privilege in memory;
means for receiving a request to access one of the plurality of services available on the wireless communication device; and
means for controlling access to the service if it is determined that the at least one stored access control privilege applies to an access request.

23. A wireless communication device, comprising:
a computer platform including a processor and a memory; and
an access control module stored in the memory and in communication with the processor that is operable to receive at least one access control privilege that includes at least one access control attribute, wherein the privilege controls access to a plurality of services available on the wireless communication device, store the at least one access control privilege in the memory, and control access to at least one of the plurality of services if it is determined that at least one of the stored access control privileges apply to an access request.

24. The wireless communication device of claim 23, wherein the access control module is further operable to receive at least one access control privilege that includes at least one access control attribute, wherein the privilege controls access to a plurality of content available on the wireless communication device, store the at least one access control privilege in the memory, and control access to at least one of the plurality of content if it is determined that at least one of the stored access control privileges apply to an access request.

25. The wireless communication device of claim 23, wherein the access control module is further operable to receive at least one access control privilege that includes at least one access control attribute, wherein the privilege controls access to a plurality of content available on the wireless communication device, store the at least one access control privilege in the memory, and control access to at least one of the plurality of content if it is determined that at least one of the stored access control privileges apply to an access request.

26. The wireless communication device of claim 23, wherein the access control module further comprises a user interface operable for receiving the at least one access control privilege.

27. The wireless communication device of claim 23, wherein the access control module is further operable to receive the at least one access control privilege from a wireless network device.

28. The wireless communication device of claim 23, wherein the access control attribute is chosen from the group consisting of to whom communication may be transmitted, from whom communication may be received, a type of service, type of content received from a service, environmental conditions, state conditions and any combination of the aforementioned attributes.

29. The wireless communication device of claim 23, wherein the access control module is further operable to receive the at least one access control attribute from at least one of the group consisting of a user, a wireless device manufacturer, and a network service provider.

30. The wireless communication device of claim 23, further comprising a location determination device in communication with the processor and operable to communicate device location information to the access control module, wherein the access control module is further operable to determine access control to the at least one of the plurality of services based on the at least one access control attribute being related to the location information.

31. The wireless communication device of claim 23, further comprising a clock device in communication with the processor and operable to communicate time information to the access control module, wherein the access control module is further operable to determine access control to the at least one of the plurality of services based on the at least one access control attribute being related to the time information.

32. The wireless communication device of claim 23, wherein the access control module that is operable to control access to the service is further operable to prohibit access to the at least one of the plurality of services.

33. The wireless communication device of claim 23, wherein the access control module that is operable to control access to the service is further operable to limit access to the at least one of a plurality of services.

34. The wireless communication device of claim 33, wherein the access control module that is operable to limit access to the service further defines limiting access as chosen from the group consisting of limiting a time for access to the service, limiting a geographic location for access to the service, limiting the type of content accessed, limiting the type of network services accessed, limiting to whom a communication may be transmitted and limiting from whom communication may be received.

35. A network device, comprising:
a computer platform including a processor and a memory;
an access control privilege database stored in the memory and operable to receive one or more access control privileges associated with a predetermined wireless communication device; and
a communication module operable to communicate access control privileges to at least one of the predetermined wireless communication device or a network device for controlling access by the wireless device to at least one of a plurality of services.

36. The network device of claim 35, wherein the access control database is further operable to receive one or more access control privileges from a third party entity in networked communication with the network device.

37. The network device of claim 35, wherein the access control database is further operable to receive one or more access control privileges from a network service provider.

38. The network device of claim 35, further comprising a network access filter module operable to wirelessly receive a request for access to a service from a wireless communication device, determine if one or more access control privileges in the database are associated with the wireless communication device and the request and control access to a service if it is determined that one or more access control privileges are associated with the wireless communication device and the request.

39. A wireless network device, comprising:
a computer platform including a processor and a memory;
a communication module executable by the processor and operable to access one or more access control privileges; and
a network access filter module stored in the memory and executable by the processor, wherein the network access filter is operable to wirelessly receive a request for access to a service from a wireless communication device, determine if the one or more access control privileges are apply to the request, and control access to the service if it is determined that one or more access control privileges are applicable to the request.

40. The wireless network device of claim 39, wherein the communication module executable by the processor and operable to access one or more access control privileges further operable to communicate with an access control server to retrieve any access control privileges that apply to the request.

41. The wireless network device of claim 39, further comprising an access control attribute database that includes a listing of access control privileges that are associated with at least one of a wireless communication device or a user.

42. The wireless network device of claim 41, wherein the communication module executable by the processor and operable to access one or more access control privileges is further operable to communicate with the access control attribute database to retrieve any access control privileges that apply to the request.

43. The wireless network device of 39, wherein the network access filter module is further operable to verify that the wireless communication device is enabled for access control.

44. The wireless network device of claim 39, wherein the network access filter module that is operable to control access to the service is further operable to prohibit access to the service if it is determined that one or more access control privileges apply to the request.

45. The wireless network device of claim 39, wherein the network access filter module that is operable to control access to the service is further operable to limit access to the service if it is determined that one or more access control privileges apply to the request.

46. A wireless communication system for controlling access to services on a wireless communication device, comprising:
an access control server including an access control privilege database operable to receive one or more access control privileges associated with a predetermined wireless communication device; and
a plurality of wireless communication devices comprising a computer platform including a processor and a memory, and an access control module stored in the memory and in communication with the processor that is operable to wirelessly receive one or more access control privileges from the access control server, store the one or more access control privileges in the memory, and control access to a service if it is determined that the stored access control privileges apply to a access request.

47. The system of claim 46, wherein the access control database is further operable to receive the one or more access control privileges from a wireless device user in networked communication with the network device.

48. The system of claim 46, wherein the access control database is further operable to receive one or more access control privileges from a third party entity.

49. A wireless communication system for controlling access to services on a wireless communication device, comprising:
a plurality of wireless communication devices; and
a first network device comprising a computer platform including a processor and a memory and a network access filter module operable to wirelessly receive an access service request from one of the plurality of wireless communication devices, determine if one or more access control privileges are associated with the request, and control access to the service if it is determined that one or more access control privileges are associated the request.

50. The system of claim 49, further comprising a second network device comprising a computer platform including a processor and a memory, and an access control attribute database stored in the memory and operable to receive one or more access control privileges associated with a predetermined wireless communication device.

51. The system of claim 50, wherein the first network device communicates with the second network device to determine if access control privileges are associated with the request.

52. The system of claim 49, further comprising a third network device comprising a computer platform including a processor and a memory, and an device-location database stored in the memory and operable to receive device-location information from the plurality of wireless communication devices.

53. The system of claim 52, wherein the third network device is operable to communicate the device-location information to the first network device if one or more of the determined access control privileges relate to device location.
